(19) United States
(12) Patent Application Publication
(10) Pub. No.: US 2026/0065141 A1
(43) Pub. Date: Mar. 5, 2026

(54) IDENTIFYING MULTI-PARTY ANONYMIZATION IN CRYPTOCURRENCY DATA

(71) Applicant: MASTERCARD INTERNATIONAL INCORPORATED, PURCHASE, NY (US)

(72) Inventors: Mohit TANEJA, Kildare (IE); John William O'MEARA, Dublin (IE); Nitish KOTHALE, Dublin (IE); Stephen Patrick FLINTER, Dublin (IE)

(21) Appl. No.: 18/824,849

(22) Filed: Sep. 4, 2024

(51) Int. Cl. G06N 20/00; G06Q 20/38

(52) U.S. Cl. CPC G06N 20/00; G06Q 20/383

(57) ABSTRACT

A computerized method trains an entry classifier model and uses the entry classifier model to identify multi-party anonymization transaction (MAT) entries. Labeled training data is obtained from a training data source and standard data features are identified therein. Engineered data features are generated using the identified standard data features. Training data features are selected from the standard data features and the engineered data features. A balanced training data subset is generated using the obtained labeled training data and an entry classifier model is trained to classify data entries as being in a MAT class based on the selected training data features using the balanced training data subset. The trained entry classifier model is used to classify an input data entry as being in the MAT class.

### BACKGROUND

COINJOIN and other multi-party anonymization transactions (MATs) are privacy-enhancing techniques used in cryptocurrency transactions, designed to obfuscate the ownership of funds by amalgamating multiple inputs, thereby complicating the task of linking identities to addresses. While traditional methods for detecting such transactions have relied on rule-based and heuristic approaches, these often fall short in addressing the complexities of advanced MAT techniques.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for training an entry classifier model and using the entry classifier model to identify MAT entries is described. Labeled training data is obtained from a training data source and standard data features are identified therein. Engineered data features are generated using the identified standard data features. Training data features are selected from the standard data features and the engineered data features. A balanced training data subset is generated using the obtained labeled training data and an entry classifier model is trained to classify data entries as being in a MAT class based on the selected training data features using the balanced training data subset. The trained entry classifier model is used to classify an input data entry as being in the MAT class.

### BRIEF DESCRIPTION OF THE DRAWINGS

The present description will be better understood from the following detailed description read considering the accompanying drawings, wherein:

FIG. 1 is a block diagram illustrating an example system configured to use labeled training data to train an entry classifier model;

FIG. 2 is a flowchart illustrating an example method for training and using an entry classifier model to identify multi-party anonymization transactions (MATs);

FIG. 3 is a flowchart illustrating an example method for generating multiple training data subsets with variable MAT class frequencies for use in training models;

FIG. 4 is a flowchart illustrating an example method for determining a subset of data features to use during model training processes; and

FIG. 5 illustrates an example computing apparatus as a functional block diagram.

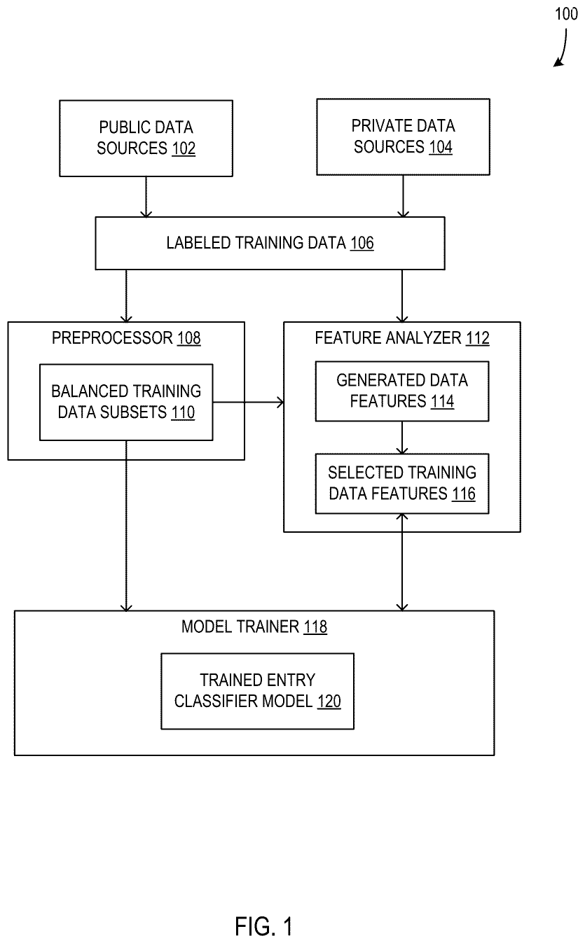

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for classifying multi-party anonymization transactions (MATs), or collaborative transactions, in cryptocurrency transaction data. Labeled training data is obtained from public and private data sources, and standard data features are identified in the obtained labeled training data. The standard data features are then used to generate a plurality of engineered data features that may be of use in accurately identifying MATs. Training data features are selected from the standard data features and the engineered data features (e.g., based on calculated importance scores of the features). Balanced training data sets are generated from the labeled training data, and entry classifier models are trained using those balanced training data sets and the selected training data features. The trained entry classifier models are then used to classify data entries as being in the MAT class or in the non-MAT class.

Examples of the disclosure operate in an unconventional manner at least by selecting (e.g., curating) the training data features and the balanced training data subsets, and using the selected training data features and the balanced training data subsets for training entry classifier models. By optimizing the features and training data subsets used for the training, the resulting trained entry classifier models are resource efficient and technically accurate. Further, the processing resources and other system resources consumed during the training of the entry classifier models are reduced when compared to processes that lack these optimization steps.

Further, aspects of the disclosure optimize the MAT class frequency to use in the balanced training data subsets, which contributes to the efficiency improvements of the process as a whole. Additionally, in some examples, the quantity of training data features used in the training process is optimized to ensure that the resulting models are technically accurate and operate quickly enough to be used to classify transaction entries in real time or near real time.

Aspects of the disclosure include a data-driven approach and machine learning techniques employed to detect MAT transactions effectively. The initial phase of data engineering is crucial for preparing a robust dataset that captures the complex characteristics of MAT transactions for training accurate classifier models. This structured approach maximizes the predictive performance of the resultant model, and also ensures the interpretability and reproducibility of the results.

FIG. 1 is a block diagram illustrating an example system configured to use labeled training data 106 to train an entry classifier model 120. In some examples, the labeled training data 106 is obtained from public data sources 102 and/or private data sources 104. A preprocessor 108 is used to generate balanced training data subsets 110 from the labeled training data 106 and a feature analyzer 112 is used to determine selected training data features 116 from a set of possible generated data features 114. The model trainer 118 is used to train the entry classifier model 120 using the balanced training data subsets 110 and the selected training data features 116. Then, the trained entry classifier model 120 is used to determine whether a transaction entry is associated with a MAT transaction or another type of transaction, and that determination is used to make decisions about how to analyze or otherwise use the transaction entry.

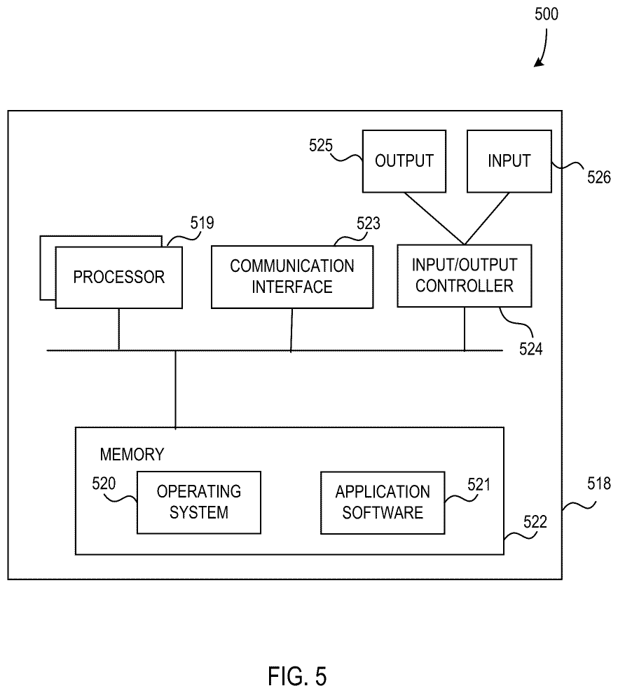

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the preprocessor 108 is executed on a first computing device and the model trainer 118 is located on a second computing device within the system 100. The first computing device and second computing device are configured to communicate with each other via network connections. Alternatively, in some examples, components of the feature analyzer 112 (e.g., a component for generating the generated data features 114 and a component for selecting the training data features 116 from those generated data features 114) are executed on separate computing devices and those separate computing devices are configured to communicate with each other via network connections during the operation of the feature analyzer 112. In other examples, other organizations of computing devices are used to implement system 100 without departing from the description.

The labeled training data 106 is obtained and/or generated based on data from public data sources 102 and/or private data sources 104. In some examples, data from the public data sources 102 and private data sources 104 is associated with transactions, such as MATs (e.g., COINJOIN) that are used in association with cryptocurrency. MATs are used to anonymize the ownership of cryptocurrency in order to make external tracking of the cryptocurrency more difficult. In a MAT, multiple parties agree to mix their cryptocurrency in a single transaction, wherein the output of the transaction leaves the participants with the same quantity of cryptocurrency but with associated addresses that have been mixed.

In some examples, the public data sources 102 and/or the private data sources 104 store data associated with MATs and other transactions that are not MATs. The labeled training data 106 is engineered or otherwise generated based on accessible data from the public data sources 102 and/or the private data sources 104. Public data sources 102 store and/or provide basic data about MATs, such as the datetime at which the transaction occurred, the total quantity of the transaction, account numbers or addresses involved in the transaction, and the like. Alternatively, or additionally, private data sources 104 store and/or provide data that is based on additional analysis of the transaction data, such as indicators that account numbers involved in the transaction are known bad actors, or the like. In some such examples, open source intelligence tools are used for investigation, analysis, and/or labelling of the data from the public data sources 102 and/or private data sources 104. Additionally, or alternatively, private data analysis and/or data labelling are used.

Further, in some examples, raw blockchain data is stored in nested files (e.g., JSON APACHE AVRO) in cloud data storage buckets (e.g., GOOGLE CLOUD PLATFORM (GCP)). The raw blockchain data is modified and/or engineered into suitable form for data analysis. For instance, in some examples, the data is un-nested from the nested files and stored as usable tabular data. The tabular data is queried to produce a range of engineered descriptive statistical features (e.g., the generated data features 114 as described in greater detail below). The engineered features are combined with other features that are present in the data to create a final tabular format of transaction-level data features suitable for machine learning. The selection of features (e.g., the selected training data features 116) is described in greater detail below.

In some such examples, the features include statistical features, such as average values, maximum values, minimum values, median values, standard deviations, and recurring counts. Further, in some examples, the features include attribution label counts of addresses associated with the transaction entries, such as illicit counts, ATM counts, criminal counts, and/or dark market counts, each of which indicates a number of times the associated address has been determined to be involved with types of transactions. Additionally, or alternatively, the features include transaction features such as a number of addresses or accounts inputting funds to the transaction, a number of addresses receiving output funds from the transaction, total funds input to and output from the transaction, indicators as to whether the transaction is considered illicit or sanctioned, or the like. Further, in some examples, the features include block-level features, such as block height, block ingestion timestamps, number of transactions in the block, or the like.

The labeled training data 106 includes some of the data (e.g., transaction data entries) from the public data sources 102 and/or private data sources 104 and labels regarding types of transactions associated with the data. For instance, in an example, the labeled training data 106 includes a series of transaction data entries associated with MATs and other transactions and, for each transaction data entry, a label is assigned that indicates whether the associated transaction is a MAT or not (e.g., a table that stores transaction identifiers (IDs) and associates each transaction ID with a binary label that indicates whether the transaction is a MAT or non-MAT). In this example, the labeled training data 106 is configured for use in training a model to classify transactions as either MATs or non-MAT transactions. It should be understood that, in other examples, other types of labels are used in the labeled training data 106 without departing from the description.

Further, in some examples, the labeled training data 106 is manually generated, in that users have previously determined the transactions that are MATs and transactions that are non-MAT transactions based on analysis of the data of those transactions. Alternatively, or additionally, in some examples, the labeled training data 106 is automatically generated using a model or other automated process without departing from the description.

Additionally, in an example of the disclosure, the full tabular data set includes the combination of engineered features, standard features, and labels used as ground truths. The exemplary experimental data set consisted of 735 million rows of data across 110 features and occupied 623 Gigabytes (GB) of storage space. Label frequency analysis was performed through queries on the data set. No usable transaction and block timestamp features were available in the data set, so block height was used for transaction sequence identification. For frequency analysis of MAT transactions, block height is matched to exact datetimes. An operation is performed that takes a UTC date as an argument and returns the block height of the first and last block mined that day. This operation enabled the creation of queries to return counts of MAT transactions and non-MAT transactions broken down by year, month, and day, thus providing a detailed picture of the frequency of MAT use across the data set.

The preprocessor 108 includes hardware, firmware, and/or software configured to perform preprocessing operations on the labeled training data 106 in order to form balanced training data subsets 110 which can then be used by the model trainer 118. In some examples, the labeled training data 106 includes significantly more non-MAT entries than MAT entries and, to train an accurate, efficient model, the training data must be balanced. For instance, in some examples, the balanced training data subsets 110 are generated by using a first quantity of MAT entries and then a second quantity of non-MAT entries and the ratio of the first quantity to the second quantity is controlled such that it remains in a defined range. Alternatively, or additionally, in some examples, synthetic transaction entries are generated to improve the ratio of MAT entries to non-MAT entries and enable more successful training processes.

Further, in some examples, the complete data set of the labeled training data 106 is too large to be loaded into RAM for training purposes, thus requiring the generation of the balanced training data subsets 110. Transactions from the labeled training data 106 are chosen stochastically to create a balanced training data subset 110 with a defined quantity of transaction entries (e.g., 100,000 transactions). In order to reach the balance between MAT entries and non-MAT entries as described above, a modified stochastic selection operation is used, such that specific quantities of MAT entries and non-MAT entries are selected for inclusion in the balanced training data subset 110. Additionally, or alternatively, in some examples, some of the balanced training data subsets 110 are formed to have different ratios of MAT entries to non-MAT entries than other balanced training data subsets 110. Such differences enable the system 100 to test different balances between MAT and non-MAT entries in order to determine the best balance to correct for or otherwise address bias between MAT and non-MAT entries during the model training process. In some such examples, the different balances range from a balanced training data subset 110 that includes 0.1% MAT entries up to a balanced training data subset 110 that includes 50% MAT entries.

The feature analyzer 112 includes hardware, firmware, and/or software configured for generating data features 114 and selecting training data features 116 from those generated data features 114. In some examples, the feature analyzer 112 obtains standard features from the labeled training data 106, wherein standard features are data features that are already present in the transaction entries of the labeled training data 106 (e.g., datetime features, account number or identifier features, transaction amount features, or the like). Further, the feature analyzer 112 generates engineered features (e.g., the generated data features 114) based, at least in part, on the standard features (e.g., an indicator that indicates whether a standard feature of each transaction falls within a defined value range). The generated data features 114 include the combined set of standard features and engineered features. The feature analyzer 112 uses one or more processes as described below to select features from the generated data features 114 to be the selected training data features 116 (e.g., based on the importance of the features to the model training process).

Further, in some examples, feature analysis by the feature analyzer 112 and/or users associated therewith include an inspection of the generated data features 114 and application of domain knowledge to remove features that are not useful in model training, such as timestamps and hash features. The remaining features are analyzed for cardinality and any single value features are removed. In some such examples, each of the balanced training data subsets 110 are analyzed to ensure that the subsets 110 include full variability of the overall data (e.g., ensuring that subsets with lower balance values do not have additional features with single value cardinality).

The remaining features are subdivided into numerical, categorical, and target feature categories and then further analyzed. For instance, in some examples, Pearson Correlation analysis is applied to numerical and categorical features to reveal correlations with target features, along with correlation between non-target feature pairs. Visualizations of probability distributions for each numerical feature are used to reveal non-parametric distributions within the numerical features. Additionally, or alternatively, in some examples, Spearman Correlation analysis is performed to reveal any monotonic relationships and/or to observe additional inter-feature correlations. The results of these analyses are used during the selection of training data features 116 as described below.

The model trainer 118 includes hardware, firmware, and/or software configured to train an entry classifier model 120 using machine learning techniques. In some examples, the model trainer 118 uses balanced training data subsets 110 and the selected training data features 116 to perform training operations in order to train the entry classifier model 120. For instance, in an example, the model trainer 118 trains the entry classifier model 120 to evaluate the selected training data features 116 of a transaction entry and to determine whether to classify a transaction entry as a MAT or a non-MAT. The model trainer 118 trains the trained entry classifier model 120 how to use each selected training data feature 116 based patterns of those features in the balanced training data subsets 110.

Further, in some examples, the type of model to be trained is considered. Considerations such as model size, training and inference times, and model complexity affect choice of a model suited to this task of training. For real-time MAT identification, a small model with fast inference times that still has sufficient complexity to capture the feature space of the dataset is needed. Decision Trees can achieve this with appropriate depth but tend to overfit when deep. Random Forest models mitigate this, allowing for adequate depth, balanced by variation in the ensemble members to avoid overfitting the training data.

Another advantage of Random Forest models is the native implementation of a Feature Importance Score, which is used by the feature analyzer 112 to select the selected training data features 116 in some examples. This is calculated in three steps. First, the node Gini Impurity score is calculated from the relative numbers of each class present after a split based on that feature. This score is then weighted by the probability of that node being reached, which is calculated by the number of data samples that reach that node, divided by the total samples. Finally, the weighted Impurity Score is averaged across the component trees and normalized to give an overall Importance Score for that feature. Ordering the features by Importance Score allows for a progressive feature addition strategy to determine the optimum number of features to produce the desired result.

In some examples, the feature analyzer 112 and model trainer 118 use a balanced training data subset 110 that mirrors the frequency of MATs in the labeled training data. High cardinality features are encoded using Dummy Encoding to prevent the creation of unnecessary redundant features. A 70:30 stratified train/test split is applied to the balanced training data subset 110 to preserve class distribution and the training portion used to train a series of Random Forest models. To provide a baseline for comparison, a first trained entry classifier model 120 is trained using all features. Then, starting with the feature with highest importance score, models 120 are trained with progressively more features until all features with nonzero importance scores are included. All the trained models 120 are tested using the testing portion of the data, and performance is assessed under at least one of the general metrics Accuracy, Precision, Recall, & F1-Score, and the specific metrics False Positive Rate (FPR), False Negative Rate (FNR), and False Discovery Rate (FDR).

Although significantly higher than observed in the labeled training data 106 overall, testing of the trained models 120 with the lowest MAT frequency (e.g., 0.1%) on the balanced training data subset 110 with the highest MAT frequency (e.g., 50%) provides an upper bound on how poorly the trained models 120 would perform on data with higher proportions of the minority class (i.e., MAT entries). This then allows for assessment of class balancing as a strategy to correct for these shortcomings. The class balancing strategy involves fully balancing the classes (e.g., MAT, and non-MAT entries) in a balanced training data subset 110 and then reducing the proportion of the minority class to find the optimum balance. A series of models 120 with the same range of selected training data features 116 are trained on the balanced training data subset 110 with the highest MAT frequency and then tested on the balanced training data subset 110 with the lowest MAT frequency. The percentage of minority class within the balanced training data subset 110 being used is then progressively reduced and reassessed to find the optimum range of minority class frequency distribution within the training data whereby minimal FNR could be maintained while reducing the FPR, giving an indication of what training distributions should be used in final model testing.

Further, in some examples, after the trained entry classifier model 120 is trained (e.g., to classify transaction entries as MAT or non-MAT), the trained entry classifier model 120 is tested. For example, test data sets of one million transactions (or another quantity of transactions) are prepared with MAT frequencies ranging from 0.1% up to 2%. In other examples, other MAT frequencies are used without departing from the description. The differing frequency ranges ensure that the model 120 being tested is optimized for varying frequencies within the bounds of what has been observed (e.g., 2% is the highest MAT frequency observed over a year). To ensure that the test data is not contaminated, an excess of transaction entries each class is stochastically selected, and hash values of those transaction entries are compared within the training data sets. Any matches are removed, and the remaining transactions are combined and shuffled in appropriate proportions.

Additionally, in some examples, the balanced training data subsets 110 that produced models 120 with the best results are identified. Multiple models 120 are trained on each balanced training data subset 110, with different feature subsets ranging from one feature up to all non-zero features. A subset of the trained models 120 are then selected based on performance and those trained models 120 are tested using each of the test datasets associated with the balanced training data subsets 110, allowing for the selection of the model with the best balance of performance across all test distributions.

It should be understood that, while many of the examples herein describe the classification of transaction data entries as being either in a MAT class or a non-MAT class, in other examples, the described systems and methods are applied to other types of data entries and other associated classes without departing from the description.

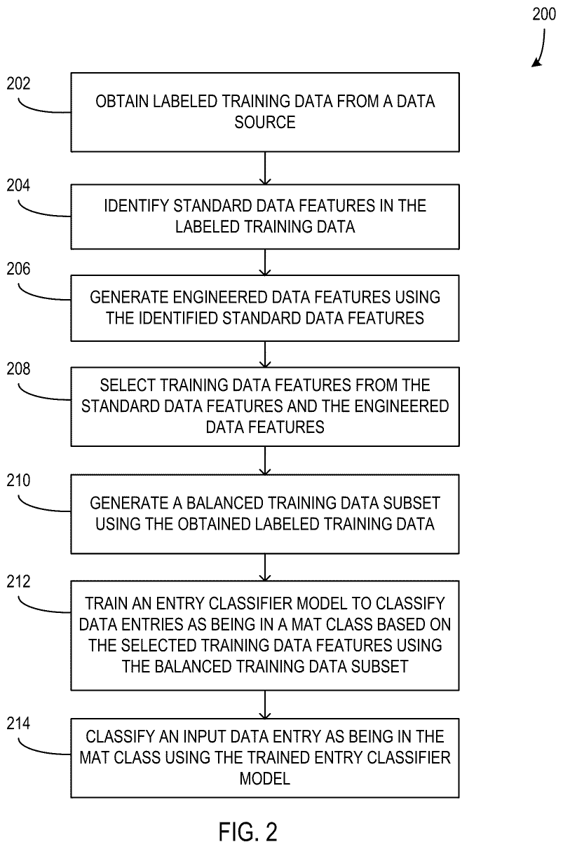

FIG. 2 is a flowchart illustrating an example method 200 for training and using an entry classifier model (e.g., trained entry classifier model 120) to identify multi-party anonymization transactions (MATs). In some examples, the method 200 is executed or otherwise performed in association with a system such as system 100 of FIG. 1.

At 202, labeled training data is obtained from a data source. In some examples, the labeled training data is obtained from public data sources 102 and/or private data sources 104. The labels associated with data entries in the labeled training data indicate at least whether the associated transaction is in the MAT class or the non-MAT class.

At 204, standard data features are identified in the labeled training data. In some examples, the standard data features include features such the total quantity of funds of the transaction, quantity of inputting accounts to the transaction, quantity of receiving accounts of the transaction, timestamp data of the transaction, or the like.

At 206, engineered data features are generated using the identified standard data features. In some examples, the engineered data features include descriptive statistical features that are generated based on values of the standard data features.

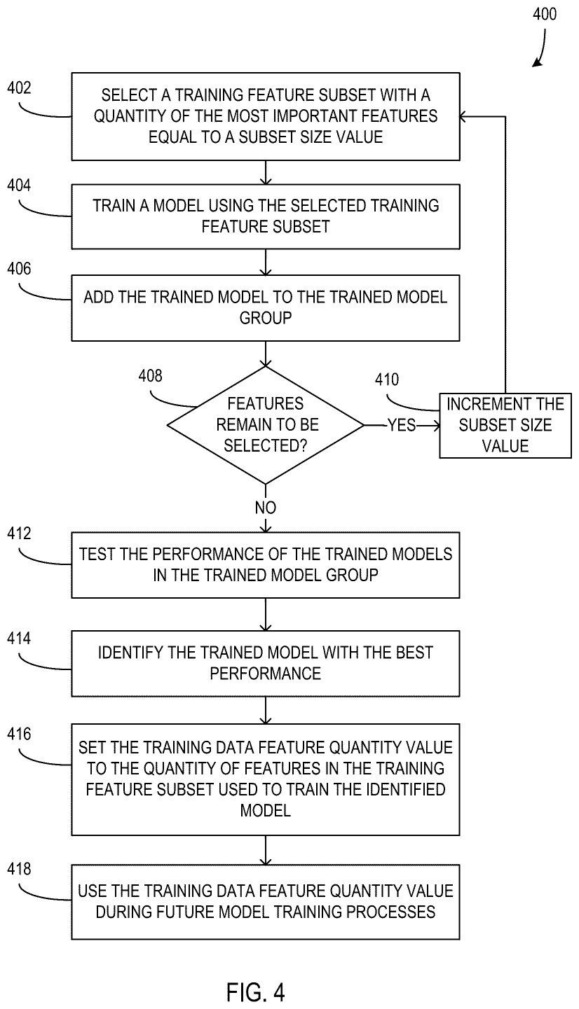

At 208, training data features are selected from the standard data features and the engineered data features. In some examples, selecting the training data features includes calculating or otherwise determining an importance score for each data feature as described herein. The importance score represents a degree to which the associated data feature accurately reflects the class of the associated data entry. The importance scores are used to order the data features and then some quantity of data features is selected from the ordered list, starting with the data feature with the highest importance score. The quantity of data features selected can be defined or an optimized quantity can be determined as described below with respect to FIG. 4.

Further, in some examples, the determination of importance scores includes generating random forest models using the standard data features and engineered data features and determining impurity values (e.g., Gini Impurity values) for the standard data features and engineered data features. Then, weight values are calculated for the data features that are indicative of probabilities that associated nodes will be reached in the generated random forest. Weighted impurity values are formed by combining the impurity values and the weight values for each data feature and feature importance scores are calculated for each feature using the weighted impurity values, wherein weighted impurity values are averaged across component trees of the generated random forest and normalized.

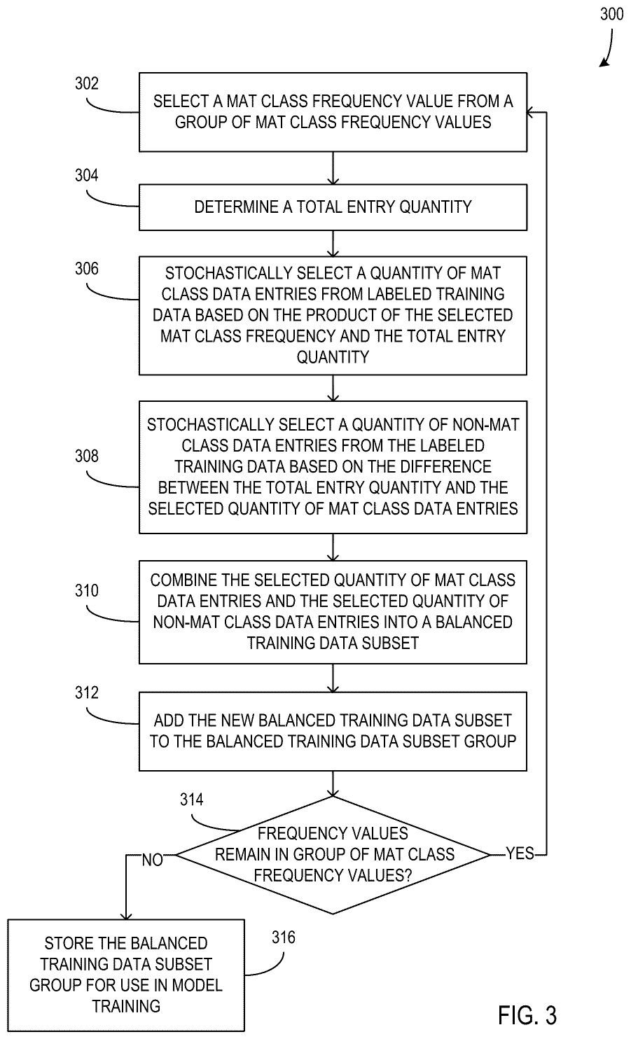

At 210, a balanced training data subset is generated using the obtained labeled training data. In some examples, a plurality of balanced training data subsets is generated from the labeled training data, wherein the training data subsets are balanced in such a way that a MAT class frequency value is met (e.g., with a MAT class frequency of 10%, the training data subsets are generated to include 10% MAT class data entries and 90% non-MAT class data entries). Further, in some examples, the plurality of balanced training data subsets includes balanced training data subsets with differing MAT class frequencies, enabling the associated system to experimentally determine the optimal MAT class frequency to use during training processes. This process is described below with respect to FIG. 3.

At 212, an entry classifier model (e.g., trained entry classifier model 120) is trained to classify data entries as being in the MAT class based on the selected training data features using the balanced training data subset. In some examples, the entry classifier model is a random forest model as described herein. Further, in some examples, multiple entry classifier models are trained using different balanced training data subsets, enabling the associated system to select the most efficient or optimized trained model for use in data entry classification processes. For instance, in an example, multiple balanced training data subsets with differing MAT class frequencies are used to train multiple entry classifier models and those multiple entry classifier models are tested and compared. The best performing entry classifier model is then selected for use in classifying transaction data entries as described herein.

At 214, an input data entry is classified as being in the MAT class using the trained entry classifier model. In some examples, the trained entry classifier model is used to classify data entries as either MAT class or non-MAT class in real time or near real time. In some such cases, the classifications by the trained entry classifier model are used when analyzing large quantities of transaction data for fraud or illicit activities, because MATs are used differently in that analysis than non-MAT transaction.

FIG. 3 is a flowchart illustrating an example method 300 for generating multiple training data subsets (e.g., balanced training data subsets 110) with variable MAT class frequencies for use in training models (e.g., trained entry classifier models 120). In some examples, the method 300 is executed or otherwise performed in association with a system such as system 100 of FIG. 1.

At 302, a MAT class frequency value is selected from a group of MAT class frequency values and, at 304, a total entry quantity is determined. In some examples, the total entry quantity is defined based on a desired training data set size for use with the machine learning techniques to be used with the training data sets. Further, in some examples, the group of MAT class frequency values includes a MAT class frequency value that reflects the MAT class frequency in the real-world data set and other MAT class frequencies between 0.1% and 50% (or another range in other examples).

At 306, a quantity of MAT class data entries is stochastically selected from labeled training data based on the product of the selected MAT class frequency value and the total entry quantity (e.g., the total entry quantity times the selected MAT class frequency value is the quantity of MAT class data entries to be selected) and, at 308, a quantity of non-MAT class data entries is stochastically selected from the labeled training data based on the difference between the total entry quantity and the selected quantity of MAT class data entries (e.g., the total entry quantity minus the selected quantity of MAT class data entries is the quantity of non-MAT class data entries).

At 310, the selected quantity of MAT class data entries and the selected quantity of non-MAT class data entries are combined into a balanced training data subset and, at 312, the balanced training data subset is added to the balanced training data subset group for later use.

At 314, if frequency values remain to be used in the group of MAT class frequency values, the process returns to 302. Alternatively, if no frequency values remain to be used, the process proceeds to 316.

At 316, the balanced training data subset group is stored for use in model training. In some examples, the balanced training data subset group is then used to train entry classifier models 120 as described herein.

FIG. 4 is a flowchart illustrating an example method 400 for determining a subset of data features (e.g., the selected training data features 116) to use during model training processes. In some examples, the method 400 is executed or otherwise performed in association with a system such as system 100 of FIG. 1.

At 402, a training feature subset with a quantity of the most important features equal to a subset size value is selected. In some examples, the subset size value starts at one during the first iteration of the process, such that the first training feature subset includes only the feature with the highest importance score.

At 404, a model is trained using the selected training feature subset and, at 406, the trained model is added to the trained model group.

At 408, if features remain to be selected from the set of potential training features, the process proceeds to 410. Alternatively, if no features remain to be selected, the process proceeds to 412. In some examples, all of the features will be used eventually during the process. In other examples, the process has a defined maximum quantity of features in a selected training feature subset (e.g., 100 features), such that time and effort is not taken to test the less important features in the set of potential training features.

At 410, the subset size value is incremented, and the process returns to 402 to select another training feature subset. In some examples, the subset size value is incremented by one, such that the described loop adds one feature of the next highest importance to the training feature subset on each iteration. In other examples, the subset size value is increased by more than one, such that the total time and processing resources required to complete the method 400 is reduced at the expense of higher granularity when testing for potential training features.

At 412, the performance of the trained models in the trained model group is tested and, at 414, the trained model with the best performance is identified. In some examples, the testing of the trained models includes measuring FPRs and FNRs of each trained model and comparing those values among the trained models. The model with the most optimal combination of FPR and FNR is selected. For instance, in an example, the FPR and FNR values are summed for each trained model and the model with the lowest summed value is selected. Alternatively, or additionally, the FPR and/or FNR are weighted differently, enabling the method 400 to flexibly select the optimal combination based in specific context of the data and/or the associated systems.

At 416, the training data feature quantity value is set to the quantity of features in the training feature subset used to train the identified model and, at 418, the training data feature quantity value is used during future model training processes.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, training entry classifier models to identify MAT class transaction entries in transaction data as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain labeled training data from a data source; identify standard data features in the obtained labeled training data; generate engineered data features using the identified standard data features; select training data features from the standard data features and the engineered data features; generate a balanced training data subset using the obtained labeled training data; train an entry classifier model to classify data entries as being in a multi-party anonymization transaction (MAT) class based on the selected training data features using the balanced training data subset; and classify an input data entry as being in the MAT class using the trained entry classifier model.

An example computerized method comprises obtaining labeled training data from a data source; identifying standard data features in the obtained labeled training data; generating engineered data features using the identified standard data features; selecting training data features from the standard data features and the engineered data features; generating a balanced training data subset using the obtained labeled training data; training an entry classifier model to classify data entries as being in one of a first class and a second class based on the selected training data features using the balanced training data subset, wherein the labeled training data includes more entries in the second class than entries in the first class; and classifying an input data entry as being in the first class using the trained entry classifier model.

One or more computer storage media have computer-executable instructions that, upon execution by a processor, cause the processor to at least: obtain labeled training data from a data source; identify standard data features in the obtained labeled training data; generate engineered data features using the identified standard data features; select training data features from the standard data features and the engineered data features; generate a balanced training data subset using the obtained labeled training data; train an entry classifier model to classify data entries as being in a multi-party anonymization transaction (MAT) class based on the selected training data features using the balanced training data subset; and classify an input data entry as being in the MAT class using the trained entry classifier model.

Alternatively, or in addition to the other examples described herein, examples include any combination of the following:
wherein generating the balanced training data subset includes: generating a first balanced training data subset with a first class frequency, the first class frequency indicating a percentage of entries in the first balanced training data subset that are in the first class; and generating a second balanced training data subset with a second class frequency, the second class frequency indicating a percentage of entries in the second balanced training data subset that are in the first class, wherein the second class frequency is greater than the first class frequency.
wherein training the entry classifier model includes: training a first candidate entry classifier model using the first balanced training data subset; training a second candidate entry classifier model using the second balanced training data subset; testing the first candidate entry classifier model and the second candidate entry classifier model; and selecting the trained entry classifier model from the first candidate entry classifier model and the second candidate entry classifier model based on results of the testing.
wherein selecting training data features from the standard data features and the engineered data features includes: generating a random forest including the standard data features and the engineered data features; determining impurity values for the standard data features and the engineered data features; calculating weight values for the standard data features and the engineered data features, wherein the calculated weight values indicate probabilities of associated nodes being reached in the generated random forest; combining the impurity values with the calculated weight values to form weighted impurity values of the standard data features and the engineered data features; calculating feature importance scores using the weighted impurity values, wherein weighted impurity values are averaged across component trees of the generated random forest and normalized for each feature; and selecting the training data features using the calculated feature importance scores.
wherein training the entry classifier model includes: training a first candidate entry classifier model using a first quantity of training data features associated with highest calculated feature importance scores; training a second candidate entry classifier model using a second quantity of training data features associated with highest calculated feature importance scores; testing the first candidate entry classifier model and the second candidate entry classifier model; and selecting the trained entry classifier model from the first candidate entry classifier model and the second candidate entry classifier model based on a result of the testing.
wherein testing the first candidate entry classifier model and the second candidate entry classifier model includes: measuring a first false positive rate (FPR) and a first false negative rate (FNR) of the first candidate entry classifier model; measuring a second FPR and a second FNR of the second candidate entry classifier model; and wherein the result of the testing includes an indicator that a combination of the first FPR and the FNR is optimized relative to a combination of the second FPR and the second FNR or that the combination of the second FPR and second FNR are optimized relative to the combination of the first FPR and the first FNR.
wherein generating the balanced training data subset includes: determining a first class frequency; stochastically selecting a first quantity of data entries that are in the first class from the labeled training data; stochastically selecting a second quantity of data entries that are in the second class from the labeled training data, wherein the second quantity is based on the determined first class frequency and the first quantity; and
combining the selected first quantity of data entries and the selected second quantity of data entries into the balanced training data subset.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining labeled training data from a data source; exemplary means for identifying standard data features in the obtained labeled training data; exemplary means for generating engineered data features using the identified standard data features; exemplary means for selecting training data features from the standard data features and the engineered data features; exemplary means for generating a balanced training data subset using the obtained labeled training data; exemplary means for training an entry classifier model to classify data entries as being in one of a first class and a second class based on the selected training data features using the balanced training data subset, wherein the labeled training data includes more entries in the second class than entries in the first class; and exemplary means for classifying an input data entry as being in the first class using the trained entry classifier model.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of. ” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
identify standard data features in labeled training data;
generate engineered data features using the identified standard data features;
select training data features from the standard data features and the engineered data features;
generate a balanced training data subset using the labeled training data;
train an entry classifier model to classify data entries as being in a multi-party anonymization transaction (MAT) class using the selected training data features and the balanced training data subset; and
classify an input data entry as being in the MAT class using the trained entry classifier model.

2. The system of claim 1, wherein generating the balanced training data subset includes:
generating a first balanced training data subset with a first MAT class frequency, the first MAT class frequency indicating a percentage of entries in the first balanced training data subset that are in the MAT class; and
generating a second balanced training data subset with a second MAT class frequency, the second MAT class frequency indicating a percentage of entries in the second balanced training data subset that are in the MAT class, wherein the second MAT class frequency is greater than the first MAT class frequency.

3. The system of claim 2, wherein training the entry classifier model includes:
training a first candidate entry classifier model using the first balanced training data subset;
training a second candidate entry classifier model using the second balanced training data subset;
testing the first candidate entry classifier model and the second candidate entry classifier model; and
selecting the trained entry classifier model from the first candidate entry classifier model and the second candidate entry classifier model based on a result of the testing.

4. The system of claim 1, wherein selecting the training data features from the standard data features and the engineered data features includes:
generating a random forest including the standard data features and the engineered data features;
determining impurity values for the standard data features and the engineered data features;
calculating weight values for the standard data features and the engineered data features, wherein the calculated weight values indicate probabilities of associated nodes being reached in the generated random forest;
combining the impurity values with the calculated weight values to form weighted impurity values of the standard data features and the engineered data features;
calculating feature importance scores using the weighted impurity values, wherein the weighted impurity values are averaged across component trees of the generated random forest and normalized for each feature; and
selecting the training data features using the calculated feature importance scores.

5. The system of claim 4, wherein training the entry classifier model includes:
training a first candidate entry classifier model using a first quantity of training data features associated with highest calculated feature importance scores;
training a second candidate entry classifier model using a second quantity of training data features associated with highest calculated feature importance scores;
testing the first candidate entry classifier model and the second candidate entry classifier model; and
selecting the trained entry classifier model from the first candidate entry classifier model and the second candidate entry classifier model based on a result of the testing.

6. The system of claim 5, wherein testing the first candidate entry classifier model and the second candidate entry classifier model includes:
measuring a first false positive rate (FPR) and a first false negative rate (FNR) of the first candidate entry classifier model;
measuring a second FPR and a second FNR of the second candidate entry classifier model; and
wherein the result of the testing includes an indicator that a combination of the first FPR and the first FNR is optimized relative to a combination of the second FPR and the second FNR or that the combination of the second FPR and second FNR is optimized relative to the combination of the first FPR and the first FNR.

7. The system of claim 1, wherein generating the balanced training data subset includes:
determining a MAT class frequency;
stochastically selecting a first quantity of data entries that are in the MAT class from the labeled training data;
stochastically selecting a second quantity of data entries that are in a non-MAT class from the labeled training data, wherein the second quantity is based on the determined MAT class frequency and the first quantity; and
combining the selected first quantity of data entries and the selected second quantity of data entries into the balanced training data subset.

8. A computerized method comprising:
identifying standard data features in labeled training data;
generating engineered data features using the identified standard data features;
selecting training data features from the standard data features and the engineered data features;
generating a balanced training data subset using the labeled training data;
training an entry classifier model to classify data entries as being in one of a first class and a second class using the selected training data features and the balanced training data subset, wherein the labeled training data includes more entries in the second class than entries in the first class; and
classifying an input data entry as being in the first class using the trained entry classifier model.

9. The computerized method of claim 8, wherein generating the balanced training data subset includes:
generating a first balanced training data subset with a first class frequency, the first class frequency indicating a percentage of entries in the first balanced training data subset that are in the first class; and
generating a second balanced training data subset with a second class frequency, the second class frequency indicating a percentage of entries in the second balanced training data subset that are in the first class, wherein the second class frequency is greater than the first class frequency.

10. The computerized method of claim 9, wherein training the entry classifier model includes:
training a first candidate entry classifier model using the first balanced training data subset;
training a second candidate entry classifier model using the second balanced training data subset;
testing the first candidate entry classifier model and the second candidate entry classifier model; and
selecting the trained entry classifier model from the first candidate entry classifier model and the second candidate entry classifier model based on a result of the testing.

11. The computerized method of claim 8, wherein selecting the training data features from the standard data features and the engineered data features includes:
generating a random forest including the standard data features and the engineered data features;
determining impurity values for the standard data features and the engineered data features;
calculating weight values for the standard data features and the engineered data features, wherein the calculated weight values indicate probabilities of associated nodes being reached in the generated random forest;
combining the impurity values with the calculated weight values to form weighted impurity values of the standard data features and the engineered data features;
calculating feature importance scores using the weighted impurity values, wherein the weighted impurity values are averaged across component trees of the generated random forest and normalized for each feature; and
selecting the training data features using the calculated feature importance scores.

12. The computerized method of claim 11, wherein training the entry classifier model includes:
training a first candidate entry classifier model using a first quantity of training data features associated with highest calculated feature importance scores;
training a second candidate entry classifier model using a second quantity of training data features associated with highest calculated feature importance scores;
testing the first candidate entry classifier model and the second candidate entry classifier model; and
selecting the trained entry classifier model from the first candidate entry classifier model and the second candidate entry classifier model based on a result of the testing.

13. The computerized method of claim 12, wherein testing the first candidate entry classifier model and the second candidate entry classifier model includes:
measuring a first false positive rate (FPR) and a first false negative rate (FNR) of the first candidate entry classifier model;
measuring a second FPR and a second FNR of the second candidate entry classifier model; and
wherein the result of the testing includes an indicator that a combination of the first FPR and the first FNR is optimized relative to a combination of the second FPR and the second FNR or that the combination of the second FPR and second FNR is optimized relative to the combination of the first FPR and the first FNR.

14. The computerized method of claim 8, wherein generating the balanced training data subset includes:
determining a first class frequency;
stochastically selecting a first quantity of data entries that are in the first class from the labeled training data;
stochastically selecting a second quantity of data entries that are in the second class from the labeled training data, wherein the second quantity is based on the determined first class frequency and the first quantity; and
combining the selected first quantity of data entries and the selected second quantity of data entries into the balanced training data subset.

15. A computer storage medium has computer-executable instructions that, upon execution by a processor, cause the processor to at least:
identify standard data features in labeled training data;
generate engineered data features using the identified standard data features;
select training data features from the standard data features and the engineered data features;
generate a balanced training data subset using the labeled training data;
train an entry classifier model to classify data entries as being in a multi-party anonymization transaction (MAT) class using the selected training data features and the balanced training data subset; and
classify an input data entry as being in the MAT class using the trained entry classifier model.

16. The computer storage medium of claim 15, wherein generating the balanced training data subset includes:
generating a first balanced training data subset with a first MAT class frequency, the first MAT class frequency indicating a percentage of entries in the first balanced training data subset that are in the MAT class; and
generating a second balanced training data subset with a second MAT class frequency, the second MAT class frequency indicating a percentage of entries in the second balanced training data subset that are in the MAT class, wherein the second MAT class frequency is greater than the first MAT class frequency.

17. The computer storage medium of claim 16, wherein training the entry classifier model includes:
training a first candidate entry classifier model using the first balanced training data subset;
training a second candidate entry classifier model using the second balanced training data subset;
testing the first candidate entry classifier model and the second candidate entry classifier model; and
selecting the trained entry classifier model from the first candidate entry classifier model and the second candidate entry classifier model based on a result of the testing.

18. The computer storage medium of claim 15, wherein selecting the training data features from the standard data features and the engineered data features includes:
generating a random forest including the standard data features and the engineered data features;
determining impurity values for the standard data features and the engineered data features;
calculating weight values for the standard data features and the engineered data features, wherein the calculated weight values indicate probabilities of associated nodes being reached in the generated random forest;
combining the impurity values with the calculated weight values to form weighted impurity values of the standard data features and the engineered data features;
calculating feature importance scores using the weighted impurity values, wherein the weighted impurity values are averaged across component trees of the generated random forest and normalized for each feature; and
selecting the training data features using the calculated feature importance scores.

19. The computer storage medium of claim 18, wherein training the entry classifier model includes:
training a first candidate entry classifier model using a first quantity of training data features associated with highest calculated feature importance scores;
training a second candidate entry classifier model using a second quantity of training data features associated with highest calculated feature importance scores;
testing the first candidate entry classifier model and the second candidate entry classifier model; and
selecting the trained entry classifier model from the first candidate entry classifier model and the second candidate entry classifier model based on a result of the testing.

20. The computer storage medium of claim 15, wherein generating the balanced training data subset includes:
determining a MAT class frequency;
stochastically selecting a first quantity of data entries that are in the MAT class from the labeled training data;
stochastically selecting a second quantity of data entries that are in a non-MAT class from the labeled training data, wherein the second quantity is based on the determined MAT class frequency and the first quantity; and
combining the selected first quantity of data entries and the selected second quantity of data entries into the balanced training data subset.
